(19) United States
(12) Patent Application Publication
(10) Pub. No.: US 2015/0128780 A1
(43) Pub. Date: May 14, 2015

(54) DEVICE FOR REMOVING BURRS FROM WORKPIECES

(71) Applicant: HON HAI PRECISION INDUSTRY CO., LTD., New Taipei (TW)

(72) Inventor: CHANG-WEI KUO, New Taipei (TW)

(73) Assignee: HON HAI PRECISION INDUSTRY CO., LTD., New Taipei (TW)

(21) Appl. No.: 14/133,484

(22) Filed: Dec. 18, 2013

(30) Foreign Application Priority Data
Nov. 8, 2013 (TW) 102140607

(51) Int. Cl. B26F 1/14; B26D 7/18

(52) U.S. Cl. CPC B26F 1/14; B26D 7/18; B26D 2007/1809
USPC 83/144

(57) ABSTRACT

A device is configured for removing burrs from workpieces. The device includes a supporting plate, an ejector plate, and a press plate. The supporting plate defines a number of holding holes for receiving the workpieces. The ejector plate is configured for ejecting the workpieces out of the holding holes. The press plate includes pressing poles for removing the burrs from the workpieces.

### BACKGROUND

1. Technical Field

The present disclosure relates to a device for removing burrs from workpieces.

2. Description of Related Art

Workpieces may have burrs formed thereon from manufacturing processes. However, it is time-consuming to remove the burrs manually and one-by-one.

Therefore, it is desirable to provide a burr-removing device for removing burrs from workpieces to overcome the limitations described.

### BRIEF DESCRIPTION OF THE DRAWINGS

The components of the drawings are not necessarily drawn to scale, the emphasis instead being placed upon clearly illustrating the principles of the embodiments of the present disclosure. Moreover, in the drawings, like reference numerals designate corresponding parts throughout several views.

FIG. 1 is a schematic view of a first embodiment of a device for removing burrs from workpieces.

FIG. 2 is an exploded view of the device of FIG. 1.

FIG. 3 is another exploded view of the device of FIG. 1.

FIG. 4 is a cross-sectional view taken along line IV-IV of FIG. 1.

FIG. 5 is an enlarged view of a circled portion V of FIG. 4.

FIG. 6 is a schematic view of a second embodiment of a device for removing burrs from workpieces.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

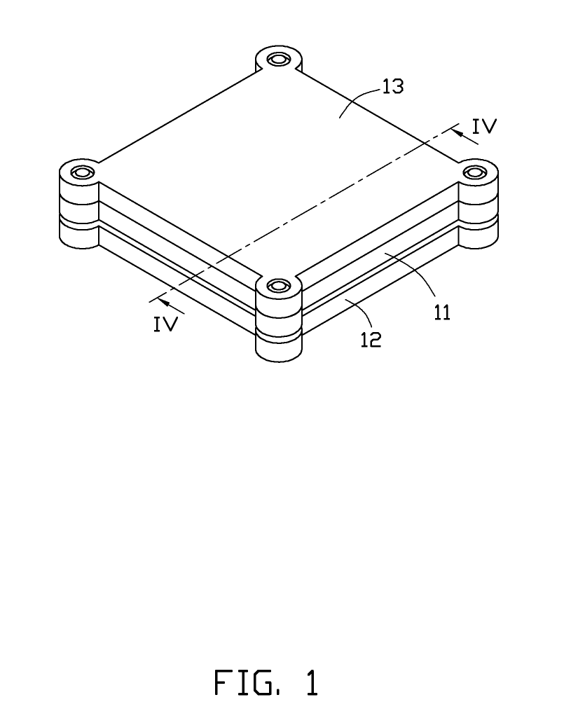

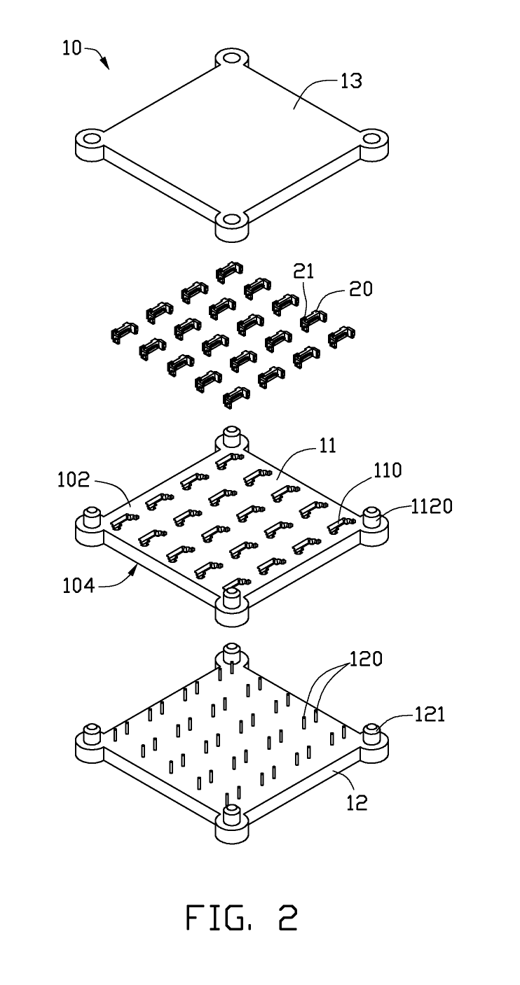

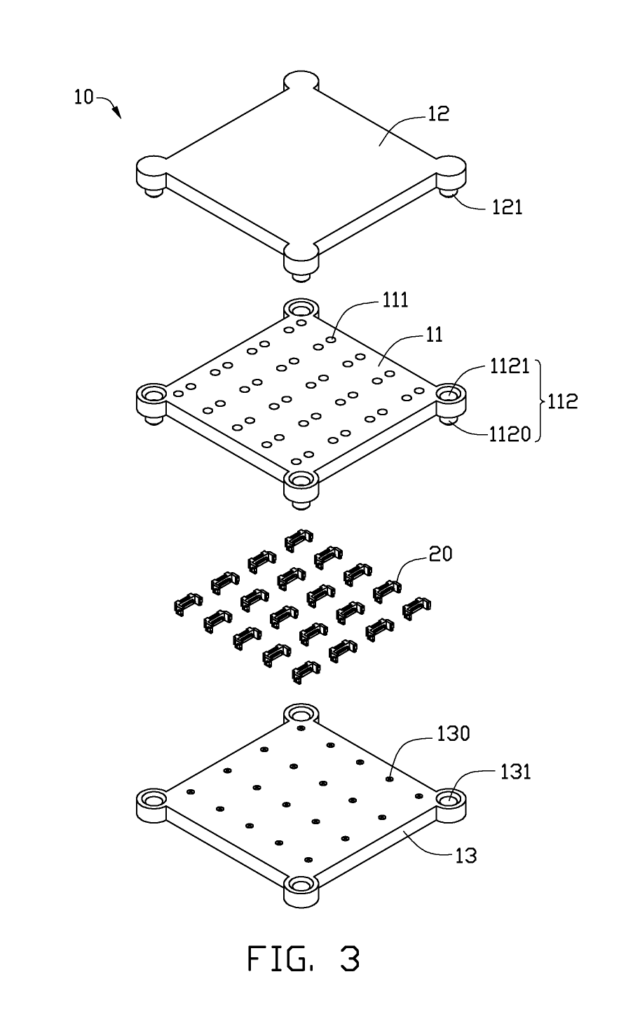

FIGS. 1-3 show an exemplary embodiment of a device 10 for removing burrs 21 from workpieces 20. The device 10 comprises a supporting plate 11, an ejector plate 12, and a press plate 13. The supporting plate 11, the ejector plate 12, and the press plate 13 can be made of, but are not limited to be made of, stainless steel, iron, and/or copper.

The supporting plate 11 is configured for supporting the workpieces 20. The supporting plate 11 is substantially square. The supporting plate 11 comprises a first surface 102 and a second surface 104 opposite to the first surface 102. The supporting plate 11 defines a plurality of holding holes 110 in the first surface 102 and defines a plurality of through holes 111 in the second surface 104. Four first location units 112 are formed at four corners of the supporting plate 11 respectively. Each holding hole 110 receives one corresponding workpiece 20. The through holes 111 communicate with corresponding holding holes 110. In one embodiment, one holding hole 110 communicates with two through holes 111. The supporting plate 11 is connected to the ejector plate 12 and the press plate 13 by the first location units 112. Each first location unit 112 comprises a location pole 1120 and defines a location hole 1121. The location poles 1120 correspond to the press plate 13. Each location pole 1120 is substantially coaxial with the corresponding location hole 1121.

A shape of the ejector plate 12 is substantially the same as a shape of the supporting plate 11. The ejector plate 12 comprises a plurality of pins 120 and four second location units 121. The four second location units 121 correspond to the four first location units 112 one-to-one. Each second location unit 121 is received in one corresponding location hole 1121, and each pin 120 is received in one corresponding through hole 111 of the supporting plate 11.

A shape of the press plate 13 is substantially the same as the shape of the supporting plate 11. The press plate 13 forms a plurality of pressing posts 130 and four third location units 131. The four third location units 131 correspond to the four first location units 112 one-to-one. The pressing posts 130 remove the burrs 21 when the press plate 13 is assembled to the supporting plate 11.

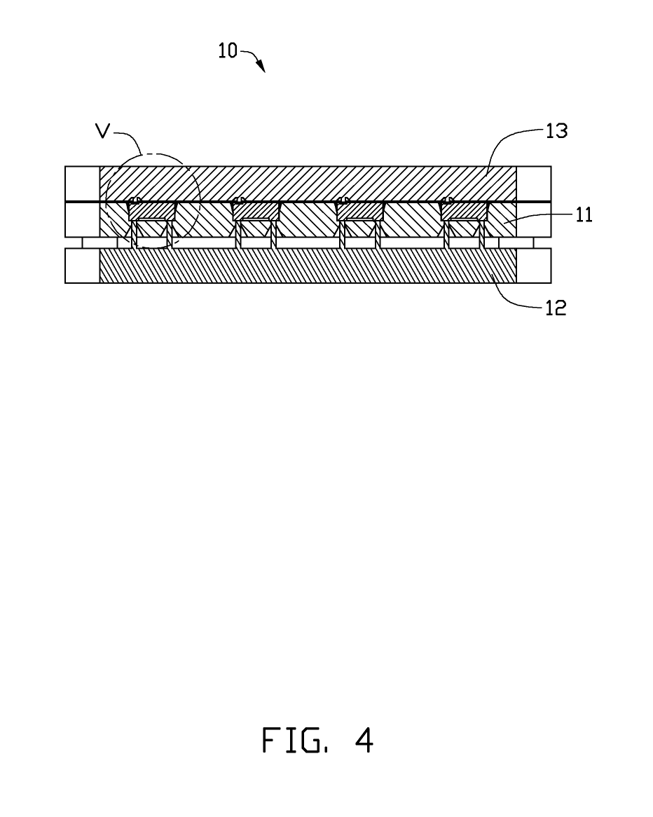

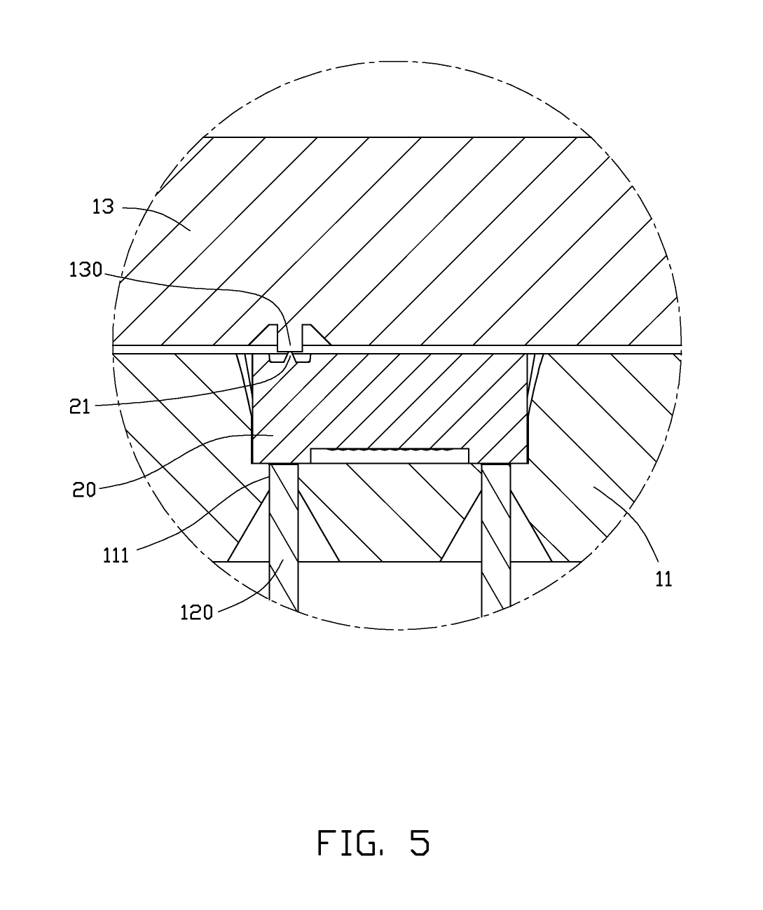

Referring to FIGS. 4-5, in use, the workpieces 20 are received in the holding holes 110, such that the burrs 21 face the press plate 13. The press plate 13 is assembled to the supporting plate 11, such that the third location units 131 receive the location poles 1120 of the first location unit 112. As the press plate 13 is assembled to the supporting plate 11, the pressing posts 130 resist against the burrs 21 of the workpieces 20 and break the burrs 21 off from the workpieces 20. After the burrs 21 are removed, the press plate 13 is removed from the supporting plate 11. The ejector plate 12 is assembled to the supporting plate 11, such that the pins 120 are received through the through holes 111. The pins 120 eject the workpieces 20 from the holding holes 110 of the supporting plate 11.

The device 10 uses the pressing posts 130 to remove the burrs 21 from the workpieces 20. The press plate 13 can remove the burrs 21 from many workpieces 20 simultaneously, and the ejector plate 12 can eject the many workpieces 20 simultaneously. Thus, the device 10 saves time and is easy to use.

In other embodiments, the location poles 1120 protrude toward the ejector plate 12. Numbers and arrangements of the first location unit 112, the second location unit 121, and the third location unit 131 can be changed according to actual needs.

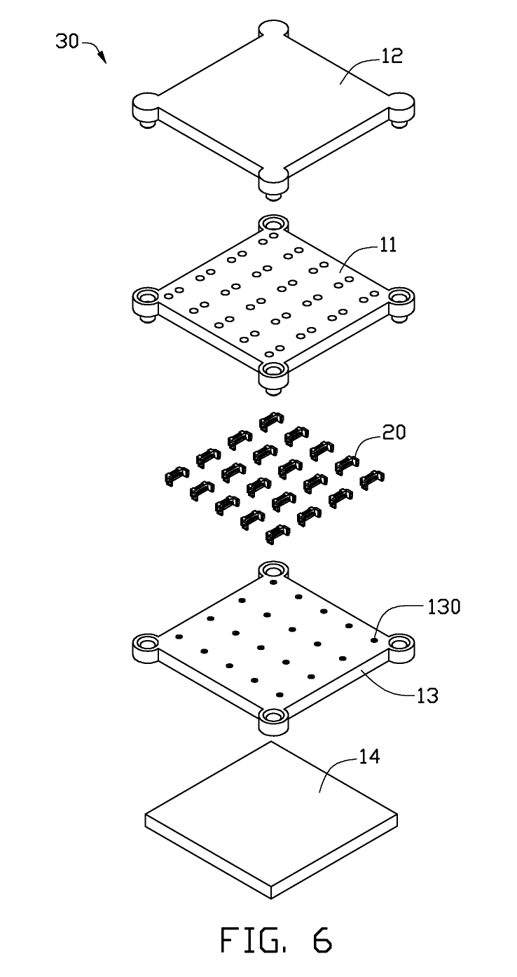

FIG. 6 shows a second exemplary embodiment of a device 30 for removing burrs 21 from workpieces 20. The device 30 of FIG. 6 is similar to the device 10 of FIGS. 1-5 except that the device further comprises a heating unit 14.

The heating unit 14 is configured for heating the pressing posts 130 of the press plate 13. The heated pressing posts 130 can soften the burrs 21 to easily remove the burrs 21 from the workpieces 20.

The heating unit 14 also can be made of, but is not limited to be made of, stainless steel, iron, and/or copper.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely exemplary embodiments of the disclosure.

What is claimed is:

1. A device for removing burrs from workpieces, comprising:
a supporting plate, the supporting plate defining a plurality of holding holes for holding the workpieces;
an ejector plate, the ejector plate being configured for ejecting the workpieces out of the holding holes; and
a press plate, the press plate defining a plurality of pressing posts for pressing the burrs in order to remove the burrs from workpieces.

2. The device of claim 1, wherein the ejector plate comprises a plurality of pins, the supporting plate defines a plurality of through holes for holding the pins, and each of the pins is received in one corresponding through hole to eject the workpieces out of the holding holes.

3. The device of claim 1, wherein the supporting plate comprises a first location unit, the ejector plate comprises a second location unit, the supporting plate is connected on the ejector plate by the first location unit engaging with the second location unit.

4. The device of claim 3, wherein the press plate comprises a third location unit, the press plate is assembled to the supporting plate by the first location unit engaging with the third location unit.

5. The device of claim 4, wherein each first location unit comprises a location pole and defines a location hole.

6. The device of claim 5, wherein each location pole is coaxial with the corresponding location hole.

7. The device of claim 1, comprising a heat unit for heating the pressing posts.

8. The device of claim 7, wherein all of the supporting plate, the ejector plate, and the press plate is made of a material selected from the group consisting of stainless steel, iron, and copper.
